(19) United States
(12) Patent Application Publication
(10) Pub. No.: US 2014/0050125 A1
(43) Pub. Date: Feb. 20, 2014

(54) METHOD FOR DYNAMIC CHANGE OF DOWNLINK/UPLINK ALLOCATION IN LTE-TDD SYSTEMS

(71) Applicant: Wenfeng ZHANG, Plano, TX (US)

(72) Inventor: Wenfeng ZHANG, Plano, TX (US)

(73) Assignee: ZTE USA, INC., Iselin, NJ (US)

(21) Appl. No.: 13/589,016

(22) Filed: Aug. 17, 2012

(51) Int. Cl. H04J 3/16

(52) U.S. Cl. CPC H04J 3/1694
USPC 370/280

(57) ABSTRACT

A method of dynamically adjusting the downlink-uplink allocation in a TDD system, includes: transmitting a downlink-uplink allocation signal to at least one user device, wherein the allocation signals specifies a set of flexible subframes within a radio frame that can be flexibly configured as either downlink or uplink subframes; determining if a HARQ feedback signal falls within a flexible subframe; and re-assigning the HARQ feedback signal to be transmitted in a non-flexible subframe within the radio frame.

### CROSS-REFERENCE TO RELATED APPLICATIONS

This application claims priority to U.S. Provisional Patent Application No. 61/524,282, filed Aug. 16, 2011, the content of which is incorporated by reference herein in its entirety.

### FIELD OF THE INVENTION

Embodiments of the invention described herein are directed to dynamically changing downlink-uplink allocation in a Long-term Evolution, time-division duplex (LTE TDD) system.

### BACKGROUND

Advantages of the TDD system include flexibility of bandwidth allocation in the unpaired frequency band, and flexibility of choice regarding the downlink to uplink resource allocation ratio (referred to herein as “the D/U ratio”). Flexibility in setting the D/U ratio is more attractive than before because of the emergence of additional traffic service types and traffic volume turbulence, both of which have resulted from wider ranges of the D/U ratio. Once the D/U ratio is determined, it is usually reported to all served user equipment (referred to herein as “UE”) via broadcast signals transmitted to the UE. Additionally, any changes of the D/U ratio are also broadcast to the UE to inform each UE of the new D/U ratio.

In LTE TDD systems, exemplary downlink-uplink allocations are specified in Table 1. The subframes in a LTE-TDD communication protocol can be downlink subframes (marked as D), uplink subframes (marked as U) or special subframes (marked as S). The S subframe includes three fields: the Downlink Pilot Time Slot (DwPTS), the Guard Period (GP) and the Uplink Pilot Time Slot (UpPTS), which are fields known to those skilled in the art.

TABLE 1
Downlink-Uplink Allocations in LTE-TDD

| | Switch-point | Subframe number | | | | | | | | | |
|---|---|---|---|---|---|---|---|---|---|---|---|
| Configuration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

In a current release of LTE TDD, the D/U ratio configuration (numbered 0-6 as shown in Table 1 above) is contained in a system information block (SIB) that is periodically transmitted over the serving cell. It may take a relatively long time (e.g., about 640ms) to reconfigure the D/U ratio to a new value.

It has been proposed in a LTE Release-11 study to further enhance LTE TDD performance by adapting TDD D/U allocation to traffic variations. Due to rapid changes in traffic volume, changing the D/U allocation via broadcast signaling is no longer suitable. One option is to change the D/U allocation without modification of the D/U ratio in the SIB by assigning some subframes in each radio frame as flexible subframe(s) that can be dynamically used as either a downlink subframe or uplink subframe. Therefore, all the subframes in each radio frame can be categorized into two types: flexible subframes that can be dynamically switched between downlink and uplink, and non-flexible subframes that are fixed as either downlink or uplink subframes according to the TDD allocation signaling in SIB. For Rel-10 UE's, the transmission and reception always utilize non-flexible subframes to keep backward compatibility, while the new Rel-11 UE can support transmission and reception signals utilizing both flexible and non-flexible subframes.

A D/U allocation change will have a logic impact to existing HARQ timing specifications in a LTE-TDD system. As known to those skilled in the art, HARQ is the process in which traffic transmissions are acknowledged by the receiver, which sends ACK/NAK signals back to the transmitting device (e.g., base station). A traffic retransmission may be triggered upon receiving a negative acknowledgement (NAK) signal from the receiver device. The delay between traffic transmission and an acknowledge feedback signal (ACK) is typically predetermined. In addition, the delay between negative acknowledgement (NAK) and retransmission is also predetermined on the LTE uplink channel.

According to the LTE specification, the UE shall transmit ACK/NAK in uplink subframe nᵤ for traffic transmissions on the physical downlink shared channel (PDSCH) in subframe nᵤ-k, where k E K and K (defined in Table 2 entries) is called the downlink association index set of M elements {k₀,k₁, . . . k_{M-1}} depending on the subframe nᵤ and the D/U (or UL-DL) configuration. TDD ACK/NAK bundling and multiplexing is performed by a logical AND operation of all individual ACK/NAKs corresponding to HARQ packets across multiple downlink subframes (ACK/NAK bundling) or HARQ packets across a single downlink subframe.

According to the LTE specification, the UE shall transmit a new data packet or re-transmit an old data packet on the physical uplink shared channel (PUSCH) in subframe n_{D}+k_{PUSCH} upon receiving a scheduling command or an ACK/NAK signal in the downlink subframe n_{D}; the UE shall expect the ACK/NAK signal on the physical HARQ indication channel (PHICH) in downlink subframe n_{U}+k_{PHICH} for its traffic transmission on the PUSCH in subframe n_{U}. k_{PUSCH} and k_{PHICH}, are defined in Table 3 below.

TABLE 2
DL HARQ timing in LTE

| UL-DL | ACK/NAK Subframe n_{U} for PDSCH in subframe n_{U} − k | | | | | | | | | |
|---|---|---|---|---|---|---|---|---|---|---|
| allocations | 0 | 1 | 2 | 3 | 4 | 5 | 6 | 7 | 8 | 9 |
| C0 | — | — | 6 | | 4 | — | — | 6 | | 4 |
| C1 | — | — | 7, 6 | 4 | — | — | — | 7, 6 | 4 | — |
| C2 | — | — | 8, 7, 4, 6 | — | — | — | — | 8, 7, | — | — |
| | | | | | | | | 4, 6 | | |
| C3 | — | — | 7, 6, 11 | 6, 5 | 5, 4 | — | — | — | — | — |
| C4 | — | — | 12, 8, | 6, 5, | — | — | — | — | — | — |
| | | | 7, 11 | 4, 7 | | | | | | |
| C5 | — | — | 13, 12, | — | — | — | — | — | — | — |
| | | | 9, 8, 7, 5, | | | | | | | |
| | | | 4, 11, 6 | | | | | | | |
| C6 | — | — | 7 | 7 | 5 | — | — | 7 | 7 | — |

TABLE 3
UL HARQ timing in LTE

| | k_{PUSCH} for DL subframe | | | | | | | | | | k_{PHICH} for UL subframe | | | | | | | | | |
|---|---|---|---|---|---|---|---|---|---|---|---|---|---|---|---|---|---|---|---|---|
| | number n_{D}: | | | | | | | | | | number n_{U}: | | | | | | | | | |
| TDD | (PUSCH in subframe n_{D} + | | | | | | | | | | (PHICH in subframe n_{U} + | | | | | | | | | |
| UL/DL | k_{PUSCH}) | | | | | | | | | | k_{PHICH}) | | | | | | | | | |
| allocations | 0 | 1 | 2 | 3 | 4 | 5 | 6 | 7 | 8 | 9 | 0 | 1 | 2 | 3 | 4 | 5 | 6 | 7 | 8 | 9 |
| C0 | 4 | 6 | — | — | — | 4 | 6 | — | — | — | — | — | 4 | 7 | 6 | — | — | 4 | 7 | 6 |
| C1 | | 6 | — | — | 4 | | 6 | — | — | 4 | — | — | 4 | 6 | — | — | — | 4 | 6 | — |
| C2 | | | — | 4 | | | | — | 4 | | — | — | 6 | — | — | — | — | 6 | — | — |
| C3 | 4 | | — | — | — | | | | 4 | 4 | — | — | 6 | 6 | 6 | — | — | — | — | — |
| C4 | | | — | — | | | | | 4 | 4 | — | — | 6 | 6 | — | — | — | — | — | — |
| C5 | | | — | | | | | | 4 | | — | — | 6 | — | — | — | — | — | — | — |
| C6 | 7 | 7 | — | — | — | 7 | 7 | — | — | 5 | — | — | 4 | 6 | 6 | — | — | 4 | 7 | — |

With the existence of a flexible subframe, the above downlink and uplink HARQ timings may no longer be effective, because the HARQ feedback may fall into a flexible subframe that the system may need to change from an uplink subframe to a downlink subframe, or vice versa. This kind of collision results in cancellation of either the flexible subframe adaptation or HARQ feedback transmission, neither of which is desirable. In addition, because all transmission and reception signals of Rel-10 UE are limited to non-flexible subframes, the Rel-10 UE performance would be greatly impacted by the partition between flexible subframes and non-flexible subframes. Therefore, embodiments of the invention described herein provide methods for flexible subframe assignment and new HARQ timings to avoid feedback collisions that may result from the use of flexible subframes.

### DETAILED DESCRIPTION OF EXEMPLARY EMBODIMENTS OF THE INVENTION

Exemplary embodiments of the invention are described herein. As would be apparent to one of ordinary skill in the art after reading this description, these embodiments are merely exemplary and the invention is not limited to operating in accordance with these examples. It is to be understood that other embodiments may be utilized and structural changes may be made without departing from the scope of the present invention.

In one embodiment, the partition between flexible subframes and non-flexible subframes need not be fixed at one single value. Two exemplary reasons for this are:
The transmission and reception of Rel-10 UE can be restricted inside non-flexible subframes, and the amount of total Rel-10 UE's may go from high to low as the LTE system evolves from Rel-10 to later releases.
Each Rel-10 TDD D/U allocation can indicate the main traffic distribution between downlink and uplink. Even though the traffic may vary, the variation may not give the big deviation to the D/U ratio indicated in SIB.

In one embodiment, the following method to partition between flexible subframes and non-flexible subframes may be implemented:
High-layer signaling can be used to inform a UE of the set of subframes that can be configured as flexible subframe. Any subframes outside this set are treated by Rel-11 UE as non-flexible subframes. The corresponding high-layer signaling can be broadcast as a SIB broadcast signal or as a UE-specific RRC signal. According to one embodiment, there could be a default flexible subframe set when this high-layer signaling is not present. In such case, the non-flexible subframe set can be either of the exemplary choices below:
   All the subframes in the radio frame, which means the flexible subframe set is null.
   The set of subframes whose indices in the radio frame are {0,1,2,5,6}.
      Therefore the flexible subframe set includes subframes {3,4,7,8,9}
No extra signaling is needed. Each TDD allocation in Table 1 has its unique partition between flexible subframes and non-flexible subframes. In other words, the flexible subframe assignment is a function of the D/U allocation configuration index in SIB (0˜6 in Table 1).

In one embodiment, once the set of flexible subframes is determined and agreed to between a base station and UE, a HARQ timing implementation can be implemented as described below:
For a downlink HARQ ACK/NACK, if it falls into a uplink subframe X according to a Rel-10 downlink HARQ timing and that uplink subframe X belongs to the set of flexible subframes, this downlink HARQ ACK/NACK may not satisfy Rel-10 downlink HARQ timing requirements and is transmitted in the earliest non-flexible uplink subframe that is at least n1 subframes delayed after the downlink subframe where the HARQ data (re)transmission is performed, where n1 is an integer.
For an uplink HARQ ACK/NACK, if it falls into a downlink subframe Y according to Rel-10 uplink HARQ timing and that downlink subframe Y belongs to the set of flexible subframes, this uplink HARQ ACK/NACK may not satisfy Rel-10 uplink HARQ timing requirements and is transmitted in the earliest non-flexible downlink subframe that is at least n2 subframes delayed after the uplink subframe where the HARQ data (re)transmission is performed, where n2 is an integer.
   Here the integers n1 and n2 can be specified to provide sufficient processing time for the user equipment to generate HARQ ACK/NACK signals based on the HARQ data transmission requirements.

However, redirecting all HARQ ACK/NACK signals that fall into flexible subframes to the earliest available non-flexible subframe may cause a HARQ feedback jam in that non-flexible subframe. Therefore, in an alternative embodiment, another method is to spread the HARQ feedback evenly or substantially evenly over all non-flexible downlink subframes or all non-flexible uplink subframes, as necessary.

In implementation, the above described mechanisms and signaling and their variations may be implemented as computer software instructions or firmware instructions. Such instructions may be stored in one or more machine-readable storage devices connected to one or more computers or digital processors such as digital signal processors and microprocessors. In a communication system, the TDD allocation ratio adjustment and its process may be implemented in form of software instructions or firmware instructions for execution by a processor in the transmitter or its transmission controller. In operation, the instructions are executed by one or more processors to cause the transmitter or its transmission controller and receiver or receiver controller to perform the described functions and operations.

While various embodiments of the present invention have been described above, it should be understood that they have been presented by way of example only, and not of limitation. The invention is not restricted to the example architectures or configurations, but can be implemented using a variety of alternative architectures and configurations. Additionally, although the invention is described above in terms of various exemplary embodiments and implementations, it should be understood that the various features and functionality described in one or more of the individual embodiments are not limited in their applicability to the particular embodiment with which they are described, but instead can be applied, alone or in some combination, to one or more of the other embodiments of the invention, whether or not such embodiments are described and whether or not such features are presented as being a part of a described embodiment. Thus the breadth and scope of the present invention should not be limited by any of the above-described exemplary embodiments but should be accorded consistently with the scope of the claims presented below.

What is claimed is:

1. A method of dynamically adjusting the downlink-uplink allocation in a TDD system, comprising:
transmitting a downlink-uplink allocation signal to at least one user device, wherein the allocation signals specifies a set of flexible subframes within a radio frame that can be flexibly configured as either downlink or uplink subframes;
determining if a HARQ feedback signal falls within a flexible subframe; and
re-assigning the HARQ feedback signal to be transmitted in a non-flexible subframe within the radio frame.

2. The method of claim 1, wherein the allocation signal is broadcast to the at least one user device.

3. The method of claim 1, wherein the set of flexible subframes is determined based on a downlink-uplink allocation configuration index specified in a system information block (SIB).

4. The method of claim 3 wherein the allocation signal is broadcast to the at least one user device as a SIB broadcast signal.

5. The method of claim 1 wherein the wherein the allocation signal is transmitted to the at least one user device as a UE-specific RRC signal.

6. The method of claim 1, wherein if the allocation signal is not received by the at least one user device, the user device sets all subframes as non-flexible subframes.

7. A method of claim 1, wherein if the allocation signal is not received by the at least one user device, the user device sets a predetermined set of subframes as flexible subframes in the radio frame.

8. A method of claim 1, wherein if it is determined that a downlink HARQ ACK/NACK signal falls in a uplink subframe X according to a Rel-10 downlink HARQ timing protocol and that uplink subframe X belongs to a set of flexible subframes, transmitting the downlink HARQ ACK/NACK signal in am earliest available non-flexible uplink subframe that is at least n1 subframes delayed after the downlink subframe where the HARQ data transmission is performed, where n1 is an integer.

9. A method of claim 1, wherein if it is determined that an uplink HARQ ACK/NACK signal falls in a downlink subframe Y according to a Rel-10 uplink HARQ timing protocol, and the downlink subframe Y belongs to a set of flexible subframes, transmitting the uplink HARQ ACK/NACK signal in an earliest available non-flexible downlink subframe that is at least n2 subframes delayed after the uplink subframe where the HARQ data transmission is performed, where n2 is an integer.
